(19) United States
(12) Patent Application Publication
(10) Pub. No.: US 2007/0275145 A1
(43) Pub. Date: Nov. 29, 2007

(54) METHOD OF DELIVERING A HIGH INTENSITY SWEETENER TO A LIQUID FOODSTUFF

(76) Inventor: Steven J. Catani, Athens, GA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/420,560

(22) Filed: May 26, 2006

(51) Int. Cl. A23L 1/236

(52) U.S. Cl. 426/548

(57) ABSTRACT

Methods and related kits to deliver a high intensity sweetener to a liquid foodstuff, for example, a beverage are provided. The method includes spraying a solution of a high intensity sweetener onto the surface of the liquid foodstuff without the need for additional mixing to sweeten the liquid foodstuff.

### FIELD OF THE INVENTION

The present invention relates to methods to deliver a high intensity sweetener to a liquid foodstuff, for example, a beverage. More particularly, the present invention relates to a method of delivering a sweetener composition to a liquid foodstuff, without additional mixing.

### BACKGROUND OF THE INVENTION

People often add sweeteners to their foods and beverages. For example, sweeteners are added to beverages, such as, coffee and tea. Sweetening a food or beverage alters its flavor and usually increases its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Therefore, there exists a long-felt need for mechanisms that consumers may use to increase the sweetness of a product at the time of consumption that are consistent with their personal preferences and that produce minimal additional caloric burden.

The availability of high intensity sweeteners provides the ability to minimize the caloric burden involved with adding additional sweetness to a foodstuff, e.g., individual servings of beverages. For example, sucralose is about 500 to about 600 times as sweet as sucrose (a.k.a. table sugar and cane sugar). One teaspoon of sucrose (about 4-5 grams) may be replaced by about 6.7 to 10 milligrams of sucralose. The minute quantities of high intensity sweeteners needed to achieve preferred sweetening of individual servings offer the opportunity to provide new technologies to deliver sweetness to foodstuffs, including individual servings.

Methods for sweetening a liquid foodstuff are known. For example, adding sweetener to an unsweetened iced tea beverage will typically involve several steps—adding the sweetener to the unsweetened iced tea beverage followed by stirring to disperse and dissolve the sweetener to create a sweetened iced tea beverage. Such a sweetener is typically in a cube, tablet, granular, powdered, or liquid form.

Sweetening individual servings of, for example, a beverage presents a challenge in many food service situations. Frequently, at least one individual packet of a sweetener is provided along with a serving of a beverage. The packet may contain sucrose, or alternatively may contain a high intensity sweetener, such as, sucralose, aspartame, or saccharin.

However, sweetening a beverage using sweetener packets presents a number of disadvantages. For example, once opened, the entire packet and its contents must be disposed of, whether used as sweetener or discarded as waste, since there is no simple way of storing an opened packet without spillage. The consumer opens the packet, empties the contents into the beverage, and then stirs the beverage to dissolve the sweetener into the beverage. The residual packaging of the packet, unused sweetener, and the device used to stir the beverage, e.g., straw or stick, create waste. Furthermore, the transportability of individual sweetener packets may be considered by some to be inconvenient due to their size and weight.

Liquid high intensity sweetener products have also been developed. These also suffer disadvantages. These products dispense sweeteners in a drop-wise manner and produce localized areas of intense sweetness in the foodstuff. Moreover, the non-uniformity of drops delivered from a squeeze-type liquid dispenser can result in variability in the amount of sweetness delivered per dose. A liquid sweetener added drop-wise to a liquid foodstuff, e.g., a beverage such as coffee or tea will require stirring to produce uniform distribution throughout the liquid foodstuff. Moreover, there is no way to spread a drop-wise, high intensity sweetener liquid evenly over a serving of solid food such as a bowl of fruit.

Methods to provide a sweetener as a spray have also been developed. While these overcome some of the issues, they fail to address the key problem of dosing consistency as they provide no means to assure all of the sprayed sweetener is consistently delivered to the foodstuff inside a container, e.g., much of the sprayed sweetener falls outside the container. Without controlling the sprayed sweetener, delivery of the sweetener is too inconsistent to be useful for beverage applications.

In view of the foregoing, it would be advantageous to provide a method of delivering a consistent amount of high intensity sweetener to a foodstuff without additional mixing.

### SUMMARY OF THE INVENTION

One embodiment of the present invention is directed to a method of delivering a high intensity sweetener to a liquid foodstuff comprising, consisting of, and/or consisting essentially of spraying onto the surface of the liquid foodstuff a unit dose of a solution from a spraying device that produces a uniform mist spray pattern, wherein the average of the height and width of a spray pattern produced by the spraying device is less than about 3 inches at a distance of about 8 inches from the spraying device and the solution comprises, consists of, and/or consists essentially a high intensity sweetener and a solvent and substantially all of the unit dose is delivered to the surface of the liquid foodstuff.

Another embodiment of the present invention is a method of delivering sucralose to a beverage comprising, consisting of, and/or consisting essentially of spraying onto the beverage a unit dose of a solution with a spraying device that produces a uniform mist, wherein the average of the height and width of a spray pattern produced by the spraying device is less than about 3 inches at a distance of about 8 inches from the spraying device and is a circle, the solution comprises, consists of, and/or consists essentially of sucralose and water, and the unit dose of sucralose produces a Sucrose Equivalent Sweetness to about one teaspoon of sucrose.

### BRIEF DESCRIPTION OF THE DRAWINGS

FIG. 1 shows an embodiment of a square spray pattern.

FIG. 2 shows an embodiment of a rectangular spray pattern.

FIG. 3 shows an embodiment of a circular spray pattern.

FIG. 4 shows an embodiment of an oval spray pattern.

FIG. 5 shows an embodiment of a triangular spray pattern.

FIG. 6 shows an embodiment of a hexagonal spray pattern.

FIG. 7 shows a cross section of an embodiment of a spraying device in a resting position.

FIG. 8 shows a cross section of an embodiment of a spraying device in a spraying position.

FIG. 9 shows an embodiment of a spraying device and reservoir.

### DETAILED DESCRIPTION OF THE INVENTION

One embodiment of the present invention is a method of delivering a sweetener to a liquid foodstuff without additional mixing including the steps of a) providing a spraying device that produces a uniform mist wherein the average of the height and width of a spray pattern produced by the spraying device is less than about 3 inches at a distance of about 8 inches from the spraying device and b) spraying a unit dose of a solution of a sweetener in a solvent onto the surface of the liquid foodstuff using the spraying device thereby dispersing the sweetener throughout the liquid foodstuff without additional mixing, wherein substantially all of the unit dose is delivered to the surface of the beverage.

As used herein, the term “liquid foodstuff” means an ingestible material that is a fluid, e.g., a beverage, such as, water, coffee, or tea, or an ingestible material that has a fluid base and retains fluid-like properties, e.g., a soup or sauce. Liquid foodstuffs useful in the present invention include, e.g., coffee, tea, water, seltzer, milk, juices, liquors, spirits, beer, ales, soups, sauces, gravies, and the like. Preferably, the liquid foodstuff is coffee, tea, or water.

As used herein, the term “high intensity sweetener” means a substance that provides a high sweetness per unit mass as compared to sucrose and provides little or no nutritive value. Many high intensity sweeteners are known to those skilled in the art and any can be used in the present invention. Examples of high intensity sweeteners for use in the present invention include aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, sweet glycosides of steviol and iso-steviol, thaumatin, salts, derivatives, and combinations thereof. A preferred sweetener according to the present invention is sucralose.

As used herein, a gram (or other given amount) of “Sucrose Equivalent Sweetness” means the amount of high intensity sweetener needed to be added to an 8 ounce glass of water in order to provide the same sweetness as an independent 8 ounce glass of water containing 1 gram (or the other given amount) of sucrose. For example, 1/200 gram of aspartame will equal about 1 gram of Sucrose Equivalent Sweetness because aspartame is about 200 times sweeter than sucrose. Similarly, about 1/500 gram to about 1/600 gram of sucralose will provide one gram of Sucrose Equivalent Sweetness because sucralose is about 500 to about 600 times sweeter than sucrose. Therefore, one teaspoon of sucrose (about 4-5 grams) may be replaced by about 6.7 to 10 milligrams of sucralose.

As used herein, a sweetening composition is a composition that provides more than 1 gram of SES, e.g., about 0.25 teaspoons.

As used herein, all numerical ranges provided are intended to expressly include at least all numbers that fall between the endpoints of ranges.

As used herein, the term “solution” means a composition containing a high intensity sweetener dissolved or suspended in a solvent. Preferably, the solution contains sucralose dissolved in water. Preferably, the sucralose is present in the solution in an amount from about 5% to about 25% based on the total weight of the solution. More preferably, the sucralose is present in the solution in an amount from about 10% to about 25%, even more preferably from about 12% to about 15%, based on the total weight of the solution. In an embodiment of the present invention the solution contains sucralose and a lemon flavor dissolved in water.

As used herein, the term “solvent” means any food-grade liquid useful to dissolve or suspend one or more sweeteners. Examples of solvents useful in the present invention include water, ethanol, ethyl acetate, propylene glycol, and combinations thereof. Preferably, the solvent is water.

As used herein, the term “spraying device” means a device capable of producing a uniform mist of a solution. As used herein, the term “uniform mist” means an aerated form of the solution made up of substantially evenly distributed, fine droplets. Such mist results in a substantially even distribution of the sweetener on the inner surface of the container, i.e. about the same mass of sweetener/unit surface area is delivered to entire area of the spray pattern.

The uniform mist may be produced by any known spraying method or device. Examples of spraying methods and devices useful in the present invention include any device with a nozzle and a means to provide a pressurized fluid to said nozzle. These may include, for example, motor driven centrifugal or positive displacement pumps, finger driven positive displacement pumps, finger driven squeeze pumps, aerosol pressurization, and other methods and devices known to those skilled in the art. Preferably, the spraying device is a finger driven squeeze pump.

The spraying devices of the present invention produce spray patterns that allow all of the sprayed solution is delivered to the foodstuff within the container. The spraying devices of the present invention produce spraying patterns wherein with an average of the height and width of less than 3 inches at a distance of 8 inches from the spraying device. Moreover, the shape of the spray pattern produced by the spraying device may be selected, based on the shape of the container, to ensure that all of the solution sprayed is delivered to the foodstuff. For example, an oval spray pattern may be selected if the container holding the foodstuff has an oval opening. Spray patterns useful in the present invention include, for example, circles, ovals, squares, rectangles, triangles, and regular polygons.

As used herein, the term “unit dose” means a predetermined amount of sweetener sufficient to provide a desired sweetness level, e.g., equivalent to from about one-half teaspoon to about three teaspoons of sucrose, preferably from about one teaspoon to about two teaspoons. The delivery of a unit dose is dependent on the concentration of the sweetener in the solution and the volume of the solution delivered. The volume of solution needed to deliver a unit dose of the sweetener is inversely proportional to the concentration of the sweetener in the solution. For example, if the concentration of the high intensity sweetener in the solution is doubled only one half of the volume must be sprayed to deliver the same unit dose. In the present invention, multiple unit doses may be delivered as desired.

The choice of the concentration of the sweetener in the solution and the volume sprayed may be influenced by the container in which the liquid food stuff is contained. For example, if the foodstuff is in a container that has a large opening, e.g., a bowl, a high volume of a lower concentration solution might be desired to allow for dispersion of the high intensity sweetener over the large surface of the liquid foodstuff. Conversely, a low volume of a higher concentration solution might be preferable to ensure that substantially all of the solution reaches the relatively small surface area of the beverage exposed in coffee cup.

A consumer expects that a sweetener will be delivered in a specific quantity. The Just Noticeable Difference (JND) is a measure of the difference from the amount of sweetener expected that produces a difference in sweetness noticeable by a consumer. For example, the JND for high intensity sweetener in general and sucralose in particular is about ±5%. Accordingly, a high intensity sweetener should be delivered in an amount in the range that does not produce a JND (or greater difference) to satisfy the consumer.

To ensure that a high intensity sweetener is delivered at levels a within the JND range, two factors must be considered. First, the amount of high intensity sweetener actually contained in the volume of solution sprayed must accurately reflect the amount selected by the consumer. Second, substantially all of the volume of solution sprayed must be delivered to the foodstuff and not lost to the surroundings.

Accordingly, while the volume of solution delivered is adjustable or is fixed, the spraying device must deliver a volume that is accurate, i.e. is the same as that volume selected, from one spray to the next.

As used herein, the term “substantially all of the unit dose” means that amount of the unit dose required to deliver a sweetness that does not produce a JND (or greater difference). Thus, if substantially all of the unit dose is delivered to the foodstuff, the consumer will not notice a difference in sweetness from that expected.

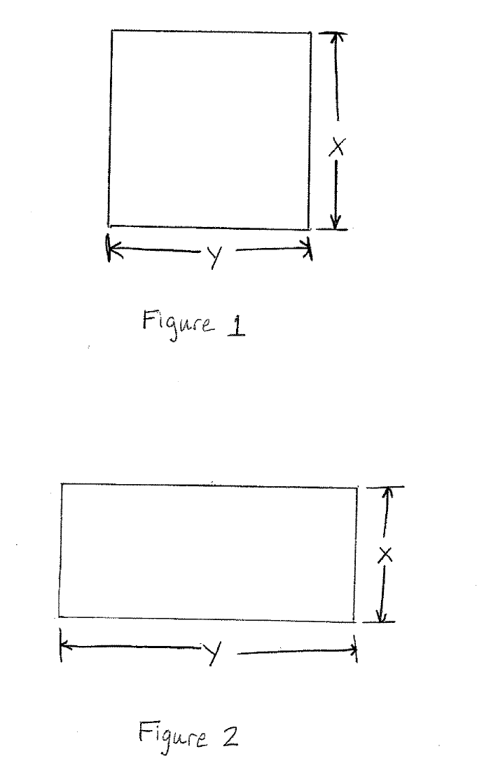

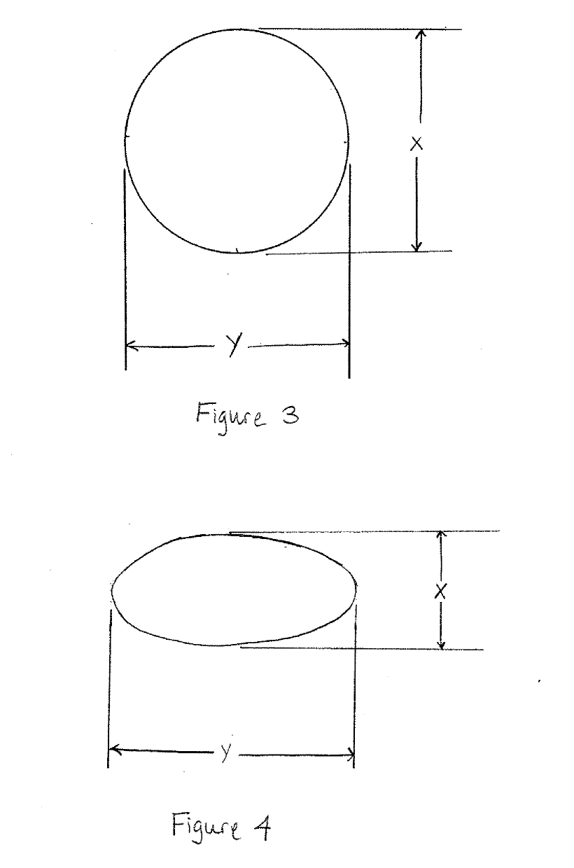

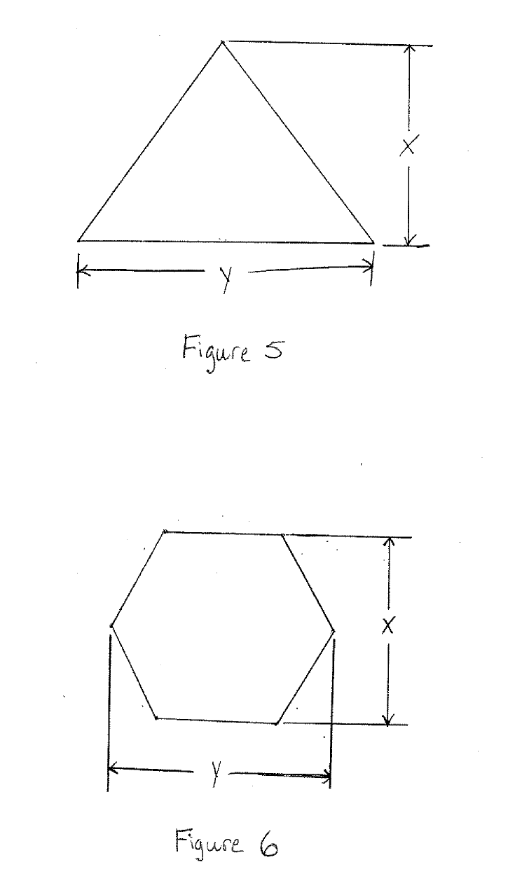

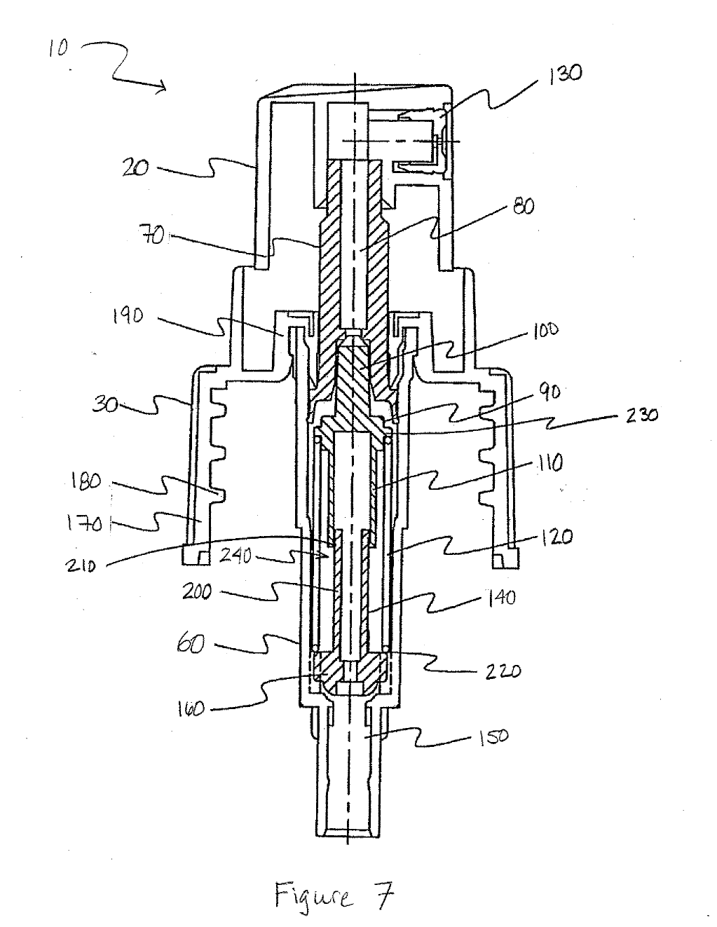

Turing now to the figures, FIG. 1 shows a square spray pattern with a height of X and a width of Y. FIG. 2 shows a rectangular spray pattern with a height of X and a width of Y. FIG. 3 shows a circular spray pattern with a height of X and a width of Y. (In FIG. 3, the height and width are equal to the diameter of the circle. They are designated height and width, herein, for clarity.) FIG. 4 shows an oval spray pattern with a height of X and a width of Y. FIG. 5 shows a triangular spray pattern with a height of X and a width of Y. FIG. 6 shows a hexagonal spray pattern with a height of X and a width of Y.

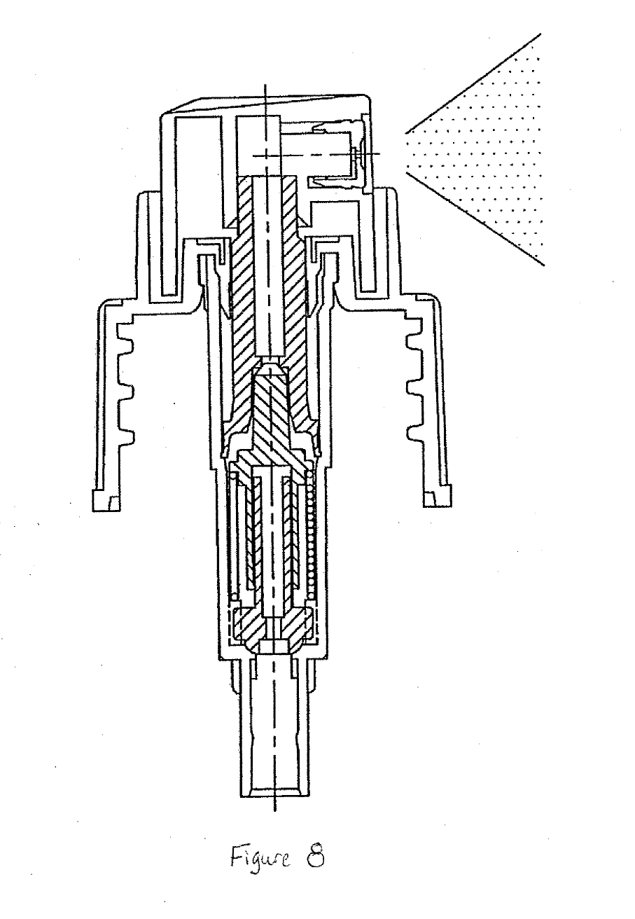

FIG. 7 shows a cross section of a finger driven squeeze pump type spraying device of the present invention. The spraying device (10) includes, a closure (30) for securely holding the spraying device (10) to the neck of a reservoir (not shown); a housing (60) for guiding the flow of the fluid to be sprayed, and which is configured as a multi-step structure; a piston (70) being moveable upwardly and downwardly along the inner surface of the housing (60), and which has a vertical duct (80) formed along the central axis thereof, a poppet valve (90) for closing and opening the vertical duct (80) with a rod (100), which has the rod (100) as an upper portion thereof and a cylindrical extending part (110) as a lower portion thereof, a spring (120) for providing an upward returning force to the poppet valve (90); a push button (20) engaged to the top of the piston (70) and having a spray orifice (130), formed at its later side, being in communication with the vertical duct (80); and a second valve (140) with a cylindrical body (200) for closing and opening a bottom entrance (150) of the housing (60) with a flared part (160), and which is disposed between the poppet valve (90) and the housing bottom entrance (150).

A cylindrical sleeve (170) of a closure (30) is screwed by a thread (180) formed thereon to the threaded neck of a reservoir. A lateral part (190) horizontally extending from the sleeve (170) is resiliently bent such that it is held fast to the top of the housing (60) while being in sliding contact with the piston (70).

The housing (60) is configured as a multi-step structure with its diameter decreasing downwardly by steps. In the bottom entrance (150) of the housing (60) is inserted a suction tube (50) (not shown), which is immersed in the fluid to be sprayed.

The cylindrical extending part (110) is formed such that the cylindrical body (200) of the second valve (140) moves upwardly and downwardly along the inner surface thereof. For ensuring resilient contact with the cylindrical body (200), an annular protuberance (210) protrudes inwardly at the bottom of the cylindrical extending part (110).

The spring (120) is positioned between the second step (220) of the housing (60) and the poppet valve (90), providing an upward returning force to the poppet valve (90) via the supporting part (230).

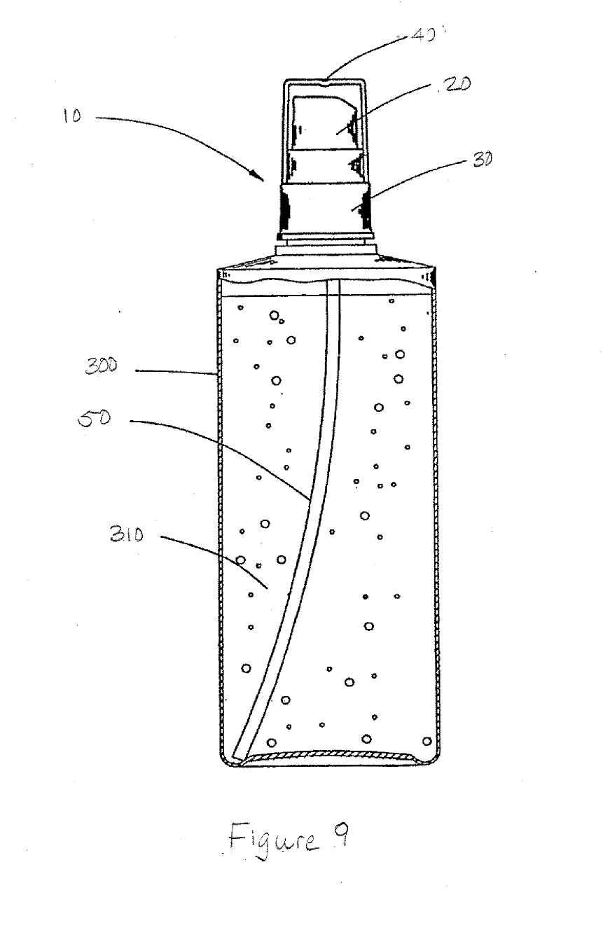

The operation of the spraying device (10) according to the present invention is described hereafter. FIGS. 7 and 8 show the cross section of the spraying device (10) in the rest mode and the spray mode, respectively.

In the rest mode (FIG. 7), no external force is applied to the spray cap (20) of the spraying device (10) and the rod (100) of the poppet valve (90) closes the vertical duct (80) of the piston (70) by an upward returning force of the spring (120). The flared part (160) of the second valve (140) is separated from the housing bottom entrance (150) to open the housing bottom entrance (150). In some cases, the flared part (160) may close the housing bottom entrance (150) by the weight of the fluid present in the housing's interior (240).

As a downward force is applied to the spraying device (10) being in the rest mode by pressing the spray cap (20), the piston (70) and poppet valve (90) are actuated, with the vertical duct (80) being closed by the rod (100). At this time, the housing bottom entrance (150) is immediately closed by the descending flared part (150), because the second valve (140), of which the cylindrical body (200) is in contact with the cylindrical extending part (110) of the poppet valve (90), descends together with the poppet valve (90) due to its frictional contact with the poppet valve (90). As the housing bottom entrance (150) is closed by the flared part (160), the housing's interior (240) is wholly sealed. As the piston (70) continues to descend under this sealing condition, the cylindrical extending part (110) of the poppet valve (90) moves downward, with its inner surface being in contact with the outer surface of the body (200) of the second valve (140), whereby the fluid present in the housing's interior (240) is pressurized.

When the pressure of the fluid present in the housing's interior (240) reaches the extent of being able to overcome the compression force of the spring (120), as mentioned above, spraying occurs as shown in FIG. 8.

FIG. 9 shows the spraying device attached to a reservoir (300) containing a solution (310). The spraying device includes a spray cap (40) over the push button (20) to prevent accidental operation of the spraying device, a suction tube (50) immersed in the solution, and a closure (30) for securely holding the spraying device (10) to the neck of a reservoir (300).

To provide flexibility in the amount of high intensity sweetener delivered, more than one spraying device may be provided, each spraying device delivering a different volume of the solution in a single spray. Accordingly, the amount of high intensity sweetener may be adjusted by selecting the spraying device. For example, if twice the amount of sweetness is desired, then a device that delivers twice the volume of solution may be selected.

In addition, the spraying device of the present invention may allow for the selection between two or more solutions with different concentrations of high intensity sweetener, or the combination of two or more solutions into a single spray. In this manner, the amount of high intensity sweetener, and if desired additional components, is highly adjustable.

The solution may also contain an additional component. Examples of additional components useful in the present invention include high intensity sweeteners, flavors, drug substances, vitamins, minerals, texture enhancers, coloring agents, aromas, preservative/buffer systems, and combinations thereof. Preferably, the additional component is a preservative/buffer system.

As used herein, “drug substance” means materials with pharmacological or nutritional benefits. Drug substances useful in the present invention include, for example, acetaminophen, ibuprofen, famotidine, chlorpheniramine, phenylephrine, pseudoephedrine, dextromethorphan, diphenhydramine, brompheniramine, clemastine, phenylpropanolamine, terfenadine, astemizole, loratadine, loperamide, loperamide-N-oxide, ranitidine, cimetidine, tramadol, cisapride, acetylsalicylic acid, doxylamine succinate, pharmaceutically acceptable salts thereof and combinations thereof.

As used herein, “flavor” means any substance that may be employed to produce a desired flavor. Any flavor know to those skilled in the art may used in the present invention. The flavor used may be selected based on the type of foodstuff that will be contacted with the device for delivering a hydrophilic composition. Flavors useful for flavoring coffee include, for example, cream, hazelnut, vanilla, chocolate, cinnamon, and pecan. In contrast, flavors useful for flavoring tea include, for example, lemon, lime, raspberry, peach, and mango. Blends of flavors are also suitable for these applications. Useful flavors include, for example, the above-mentioned flavors and vanillin, butter, butterscotch, tea, orange, tangerine, walnut, caramel, strawberry, banana, grape, plum, cherry, blueberry, pineapple, elderberry, watermelon, bubblegum, cantaloupe, guava, kiwi, papaya, coconut, mint, spearmint, green tea, chai, and pomegranate, and combinations thereof.

As used herein, “texture enhancer” means any substance that may be employed to produce a desired texture. Texture enhancers useful in the present invention include, for example, guar gum, alginate and salts thereof, taro gum, gellan gum, xanthium gum, amalose, amalopectin, konjac, and combinations thereof.

As used herein, “coloring agent” means any substance that may be employed to produce a desired color. Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), Annatto Extract, Anthocyanis, Aronia/Redfruit, Beet Juice & Powder, Beta-Carotene, Beta-APO-8-Carotenal, Black Currant, Burnt Sugar, Canthaxanthin, Caramel, Carbo Medicinalis, Carmine, Carmine/Beta-Carotene, Carmine Blue, Carminic Acid, Carrot & Carrot Oils, Chlorophyll, Chlorophyllin, Cochineal Extract, Copper-Chlorophyll, Copper-Chlorophyllin, Curcumin, Curcumin/CU-Chlorophyllin, Elderberry, Grape & Grape Skin Extracts, Hibiscus, Lutein, Mixed Carotenoids, Paprika, Paprika Extract, Paprika Oleoresin, Riboflavin, Saffron, Spinach, Stinging Nettle, Titanium Dioxide, Turmeric, and combinations thereof.

As used herein, “aroma” means any volatile substance that may be employed to produce a desired scent. Aroma components useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), d-limonene (orange) ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone (juniper, common sage, Nootka cypress, and wormwood), thymol (camphor-like), trimethylamine (fish), vanillin (vanilla), salts, derivatives, and combinations thereof Preferred aromas according to the present invention are essential oils (citrus oil), expressed oils (orange oil), distilled oils (rose oil), extracts (fruits), benzaldehyde, d-limonene, furfural, menthol, methyl butanoate, pentyl butanoate, and combinations thereof.

As used herein, “preservative/buffer system” means any food grade substance that may be employed to extend the shelf life of another hydrophilic substance. Preservative/buffer systems useful in the present invention include, for example, a preservative system selected from the group consisting of potassium sorbate, sodium benzoate, potassium benzoate, methyl gallate, propyl gallate, ethylenediaminetetraacetate, methyl paraben, propyl paraben and mixtures thereof, a buffering system selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic and a liquid, wherein the pH of the composition is from about pH 4.0 to about pH 5.5, and combinations thereof. Preferred preservative/buffer systems according to the present invention are a preservative system consisting of potassium sorbate and sodium benzoate, a buffering system consisting of citric acid and sodium citrate, and combinations thereof.

As used herein, a “food-grade” material is one that conforms to the standards for foods deemed safe for human consumption set forth in the Codex Alimentarius produced by the World Health Organization (1999).

A kit for delivering a high intensity sweetener to a liquid foodstuff without additional mixing is also provided herein. The kit includes, in packaged combination, a spraying device and instructions for using the spraying device, wherein the spraying device (a) contains a solution comprising a high intensity sweetener and a solvent (b) when sprayed, produces an uniform mist and a spray pattern having a height and width of less than about 3 inches at a distance of about 8 inches from the device and delivers a unit dose of the solution to a liquid foodstuff.

Methods of delivering sucralose or other high intensity sweeteners to a beverage or other liquid foodstuff without additional mixing including the steps of a) providing a spraying device that produces a uniform mist wherein the average of the height and width of a spray pattern produced by the spraying device is less than about 3 inches at a distance of about 8 inches from the spraying device and is a circle and b) spraying a unit dose of a solution of sucralose in water onto the surface of the beverage using the spraying device thereby dispersing the sucralose throughout the beverage without additional mixing, wherein the amount of sucralose dispersed in the beverage is sufficient to produce a sweetness equivalent to about one teaspoon of sucrose.

The following examples are provided to further illustrate the compositions and methods of the present invention. These examples are illustrative only and are not intended to limit the scope of the invention in any way.

### EXAMPLES

### Example 1

A liquid foodstuff is sweetened using the method of the present invention wherein the spraying device is a finger driven squeeze pump delivering 0.1 milliliters of solution per spray. The spraying device produces a circular spray pattern having an average of the height and width (diameter) of 2.5 inches at eight inches from the spraying device.

A solution is made by combining 25.31 grams of sucralose with 183.11 milliliters of tap water. The solution is then heated to about 130° F. and mixed until clear. The solution is allowed to cool to room temperature. Once cooled a portion of the solution is loaded into a reservoir and the reservoir is attached to the spraying device.

Coffee is brewed and 8 ounces are placed in a cup. The spraying device is used to deliver a single spray to the surface of the coffee. A tester tastes the coffee and reports that, without stirring, the spray produces a sweetness in the coffee equivalent to about two teaspoons of sucrose.

### Example 2

A liquid foodstuff is sweetened using the method of the present invention wherein the spraying device is a finger driven positive displacement pump delivering 0.25 milliliters of solution per spray. The spraying device produces a square spray pattern having an average of the height and width of 2 inches at eight inches from the spraying device.

A solution is made by combining 2 grams of sucralose with 50 milliliters of tap water. The solution is then heated to about 130° F. and mixed until clear. The solution is allowed to cool to room temperature. Once cooled a portion of the solution is loaded into a reservoir and the reservoir is attached to the spraying device.

Coffee is brewed and 8 ounces are placed in a cup. The spraying device is used to deliver a single spray to the surface of the coffee. A tester tastes the coffee and reports that, without stirring, the spray produces a sweetness in the coffee equivalent to about one teaspoon of sucrose in the coffee.

### Example 3

A liquid foodstuff is sweetened using the method of the present invention wherein the spraying device is a finger driven squeeze pump delivering 0.25 milliliters of solution per spray. The spraying device produces a triangular spray pattern having an average of the height and width of 2 inches at eight inches from the spraying device.

A solution is made by combining 2 grams of sucralose and 100 milligrams of lemon flavor with 50 milliliters of tap water. The solution is then heated to about 130° F. and mixed until clear. The solution is allowed to cool to room temperature. Once cooled a portion of the solution is loaded into a reservoir and the reservoir is attached to the spraying device.

About 8 ounces of hot herbal tea are poured into a cup. The spraying device is used to deliver a single spray to the surface of the herbal tea. A tester tastes the herbal tea and reports that, without stirring, the composition produces a sweetness in the herbal tea equivalent to about one teaspoon of sucrose and a pleasing lemon flavor.

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents.

What is claimed is:

1. A method of delivering a sweetening composition to a liquid foodstuff comprising spraying onto the surface of the liquid foodstuff a unit dose of a solution from a spraying device that produces a uniform mist spray pattern, wherein the average of the height and width of the spray pattern produced by the spraying device is less than about 3 inches at a distance of about 8 inches from the spraying device and the solution comprises a sweetener and a solvent and substantially all of the unit dose is delivered to the surface of the liquid foodstuff.

2. A method according to claim 1, wherein the sweetener is a high intensity sweetener.

3. A method according to claim 1, wherein the spraying device is manually operated.

4. A method according to claim 1, wherein the uniform mist spray pattern is selected from the group consisting of circles, ovals, squares, rectangles, triangles, and regular polygons.

5. A method according to claim 4, wherein the uniform mist spray pattern is a circle.

6. A method according to claim 1, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, sweet glycosides of steviol and iso-steviol, thaumatin, salts, derivatives, and combinations thereof.

7. A method according to claim 6, wherein the high intensity sweetener is sucralose.

8. A method according to claim 1, wherein the unit dose delivers from about one half teaspoon to about three teaspoons of sucrose equivalent sweetness to the liquid foodstuff.

9. A method according to claim 8, wherein the unit dose delivers from about one teaspoon to about two teaspoons of sucrose equivalent sweetness to the liquid foodstuff.

10. A method according to claim 1, wherein the solvent is selected from the group consisting of water, ethanol, ethyl acetate, propylene glycol, and combinations thereof.

11. A method according to claim 10, wherein the solvent is water.

12. A method according to claim 1, wherein the solution further comprises at least one additional component.

13. A method according to claim 12, wherein the additional component is selected from the group consisting of an additional high intensity sweetener, flavors, drug substances, vitamins, minerals, texture enhancers, coloring agents, aromas, preservative/buffer systems, and combinations thereof.

14. A method according to claim 13, wherein the additional component is lemon flavor.

15. A method according to claim 13, wherein the additional component is a preservative/buffer system.

16. A kit for implementing the method of claim 1 comprising, in packaged combination, a spraying device and instructions for using the spraying device, wherein the spraying device (a) contains a solution comprising a high intensity sweetener and a solvent and (b) when sprayed, produces an uniform mist spray pattern having a height and width of less than about 3 inches at a distance of about 8 inches from the device and delivers a unit dose of the solution to a liquid foodstuff.

17. A method of delivering sucralose to a beverage comprising spraying onto the beverage a unit dose of a solution with a spraying device that produces a uniform mist, wherein the average of the height and width of a spray pattern produced by the spraying device is less than about 3 inches at a distance of about 8 inches from the spraying device and is a circle, the solution comprises sucralose and water, and the unit dose of sucralose produces a Sucrose Equivalent Sweetness to about one teaspoon of sucrose.

18. A method according to claim 17, wherein the sucralose is present in the solution in an amount from about 5% to about 25% by weight based on the total weight of the solution.
